(19) United States
(12) Patent Application Publication
(10) Pub. No.: US 2024/0232736 A1
(43) Pub. Date: Jul. 11, 2024

(54) GHG EMISSION ESTIMATION APPARATUS, GHG EMISSION ESTIMATION METHOD AND PROGRAM

(71) Applicant: NIPPON TELEGRAPH AND TELEPHONE CORPORATION, Tokyo (JP)

(72) Inventors: Masahiro SOTOMA, Tokyo (JP); Minako HARA, Tokyo (JP); Atsushi SAKURAI, Tokyo (JP); Yuriko TANAKA, Tokyo (JP)

(21) Appl. No.: 18/559,382

(22) PCT Filed: May 13, 2021
(86) PCT No.: PCT/JP2021/018181

§ 371 Date: Nov. 7, 2023

(51) Int. Cl. G06Q 10/04

(52) U.S. Cl. CPC G06Q 10/04

(57) ABSTRACT

A GHG emission estimation method includes: deriving, based on a vehicle usage rate of each distance class for each precipitation amount class based on a vehicle commuting distance of each employee and precipitation amount data of each past commuting day for the precipitation amount class, a first approximation function that estimates the vehicle usage rate; deriving a second approximation function that approximates a parameter value of the first approximation function; integrating the first approximation function and the second approximation function to derive a function for estimating the vehicle usage rate; calculating a corrected vehicle usage rate in which an appearance rate of the precipitation amount class is reflected in an output value of the function for the precipitation amount class; and calculating an estimated value of estimated GHG emissions based on the distance and the number of commuting days of the employee.

### TECHNICAL FIELD

The present invention relates to a GHG emission estimation device, a GHG emission estimation method, and a program.

### BACKGROUND ART

Recently, reduction in global warming gas (hereinafter, referred to as “GHG”) emission has been promoted worldwide, and it is necessary for organizations such as companies to compute GHG emissions by their own activities. Emission intensities in various activities and things are published, and there are many companies that calculate and publish the GHG emissions by using them. In addition, in planning a reduction target of future GHG emissions and a method for realizing the reduction target, it is essential to estimate future GHG emissions by an appropriate method.

Representative things that emit GHGs include the use of automotive vehicles (hereinafter, referred to as “vehicles”). The GHG emissions due to the use of vehicles is often calculated by measuring or estimating the travel distance of the vehicles, the total amount of fuel used in the vehicles, or the like by some means and multiplying this by intensities.

On the other hand, vehicles are used for various purposes and under various environments. In addition, the way of use varies depending on human judgment. Therefore, except for a case where the travel distance of the vehicles or the like can be directly collected from sensors, a calculation result of GHG emissions due to use of the vehicles largely varies. In particular, the influence on the estimated value of the future emissions is large. Regarding a method for computing the GHG emissions, guidelines have been issued from national organizations and the like (Non Patent Literature 1).

### CITATION LIST

### Non Patent Literature

Non Patent Literature 1: Guidelines for Methods of Calculating Total Greenhouse Gas Emissions, Ver. 1.0, the Ministry of the Environment, March 2017

### SUMMARY OF INVENTION

### Technical Problem

However, with respect to a method for calculating GHG emissions, there is no technology that clearly indicates a method for reflecting a use environment of vehicles or the like.

The present invention has been made in view of the above points, and an object is to enable estimation of GHG emissions reflecting a use environment of vehicles.

### Solution to Problem

Thus, in order to solve the above problem, a GHG emission estimation method executes by a computer: a first derivation procedure of deriving, for each precipitation amount class, a first approximation function that estimates a vehicle usage rate using a distance as a variable on the basis of a vehicle usage rate of each distance class for each precipitation amount class based on a vehicle commuting distance of each employee and precipitation amount data of each past commuting day; a second derivation procedure of deriving a second approximation function that approximates a parameter value of the first approximation function using a precipitation amount as a variable; a third derivation procedure of integrating the first approximation function and the second approximation function to derive a function for estimating a vehicle usage rate using the distance and the precipitation amount as variables; a first calculation procedure of calculating a corrected vehicle usage rate in which an appearance rate of the precipitation amount class is reflected in an output value of the function for each precipitation amount class for each distance class; and a second calculation procedure of calculating an estimated value of estimated GHG emissions on the basis of the distance and the number of commuting days of each employee having the distance belonging to the distance class, the corrected vehicle usage rate, and a GHG intensity for each distance class.

### Advantageous Effects of Invention

GHG emissions reflecting a use environment of vehicles can be estimated.

### BRIEF DESCRIPTION OF DRAWINGS

FIG. 1 is a diagram illustrating a hardware configuration example of a GHG emission estimation device 10 according to an embodiment of the present invention.

FIG. 2 is a diagram illustrating a functional configuration example of the GHG emission estimation device 10 according to an embodiment of the present invention.

FIG. 3 is a flowchart for describing an example of a processing procedure executed by the GHG emission estimation device 10.

FIG. 4 is a diagram illustrating the number of employees included in each distance class and the number of vehicle users in a non-precipitation period (precipitation amount: 0 mm).

FIG. 5 is a diagram illustrating an example of an approximate curve of a vehicle usage rate using distances in a plurality of precipitation amount classes as variables.

FIG. 6 is a diagram illustrating an example of an approximation function indicating a relationship between an hourly precipitation amount and a Gompertz function parameter c.

FIG. 7 is a diagram illustrating an example of an appearance rate for each precipitation amount class at a certain meteorological observation station.

FIG. 8 is a diagram illustrating an example of a corrected vehicle usage rate for each distance class.

### DESCRIPTION OF EMBODIMENTS

In the present embodiment, an example of estimating global warming gas (hereinafter, referred to as “GHG”) emissions due to commuting using a private vehicle (assuming a normal passenger car) of an employee of a certain company will be described, in which two environmental factors that define the use/non-use of an automotive vehicle (hereinafter, referred to as a “vehicle”) are set: a distance to a destination and a precipitation amount. Note that the GHG is an abbreviation for Greenhouse Gas.

Note that the present embodiment assumes a situation in which, in order to contribute to global CO₂ emission reduction, a certain company is setting out a measure for allowing an employee who applies for commuting by vehicle (hereinafter, simply referred to as an “employee”) to commute by means of transportation other than vehicle as much as possible. In this case, it is considered that an employee who has originally had a short commuting distance has a high rate of switching to walking or cycling, and the switching rate decreases as the commuting distance increases. In addition, when it rains, it is considered that the number of employees who use a vehicle in accordance with the precipitation amount is larger than that in the case of no precipitation. The present embodiment assumes such a situation.

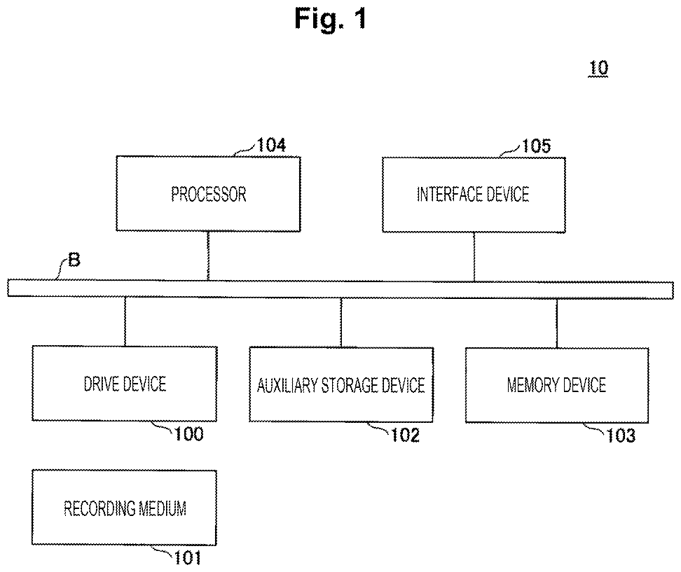

Hereinafter, an embodiment of the present invention will be described with reference to the drawings. FIG. 1 is a diagram illustrating a hardware configuration example of the GHG emission estimation device 10 according to the embodiment of the present invention. The GHG emission estimation device 10 in FIG. 1 includes a drive device 100, an auxiliary storage device 102, a memory device 103, a processor 104, an interface device 105, and the like, which are connected to each other by a bus B.

A program for implementing processing in the GHG emission estimation device 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101, but may be downloaded from another computer via a network. The auxiliary storage device 102 stores the installed program and also stores necessary files, data, and the like.

In a case where an instruction to start the program is made, the memory device 103 reads the program from the auxiliary storage device 102 and stores the program. The processor 104 is a central processing unit (CPU), a graphics processing unit (GPU), or a CPU and GPU and executes a function regarding the GHG emission estimation device 10 according to the program stored in the memory device 103. The interface device 105 is used as an interface for connecting to a network.

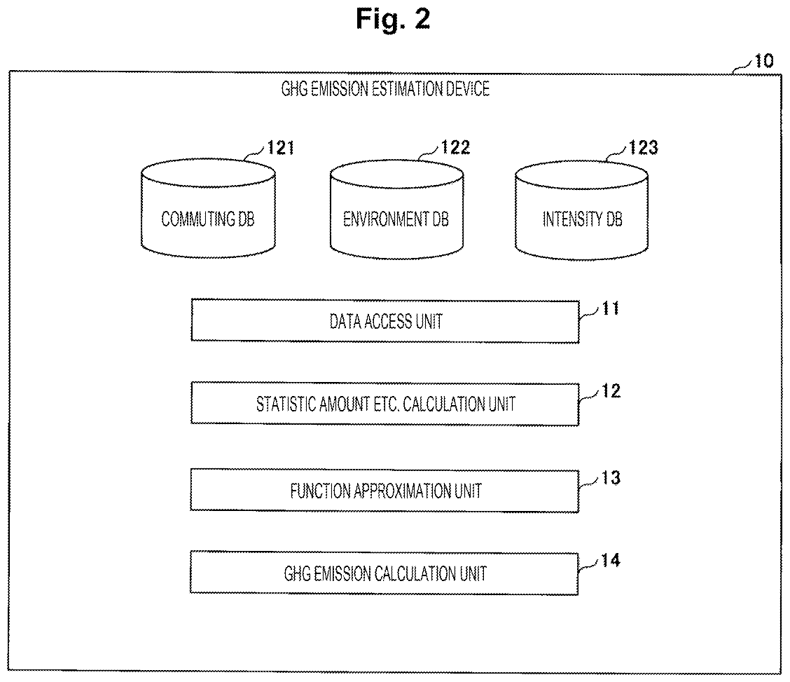

FIG. 2 is a diagram illustrating a functional configuration example of the GHG emission estimation device 10 according to the embodiment of the present invention. In FIG. 2, the GHG emission estimation device 10 includes a data access unit 11, a statistic amount etc. calculation unit 12, a function approximation unit 13, and a GHG emission calculation unit 14. Each of these units is realized by processing executed by the processor 104 by one or more programs installed in the GHG emission estimation device 10. That is, the GHG emission estimation device 10 can also be implemented by a computer and a program, and the program can be recorded in a recording medium or provided through a network. The GHG emission estimation device 10 also uses databases (storage units) such as a commuting DB 121, an environment DB 122, and an intensity DB 123. Each of these databases can be implemented using, for example, the auxiliary storage device 102, a storage device that can be connected to the GHG emission estimation device 10 via a network, or the like.

The commuting DB 121 stores data regarding commuting of employees, for example, a location of each employee's home, a commuting route by a vehicle from the home to a work place, a point-to-point distance (distance based on the commuting route), a vehicle type in a case where a vehicle (private vehicle) is used for commuting, past commuting record data, and the like. The past commuting record data refers to data including a commuting date and time (date and time of departure from home) of each employee on each commuting day and information indicating whether or not a vehicle was used for commuting on each commuting day.

The environment DB 122 stores environmental data at each point across the country, for example, geographic data such as a road network, past precipitation amount, and the like.

The intensity DB 123 stores various intensity data used at the time of calculating GHG emissions.

Note that, although not illustrated, it is assumed that each database has a function of displaying and outputting information, a function of integrating different types of data, and the like.

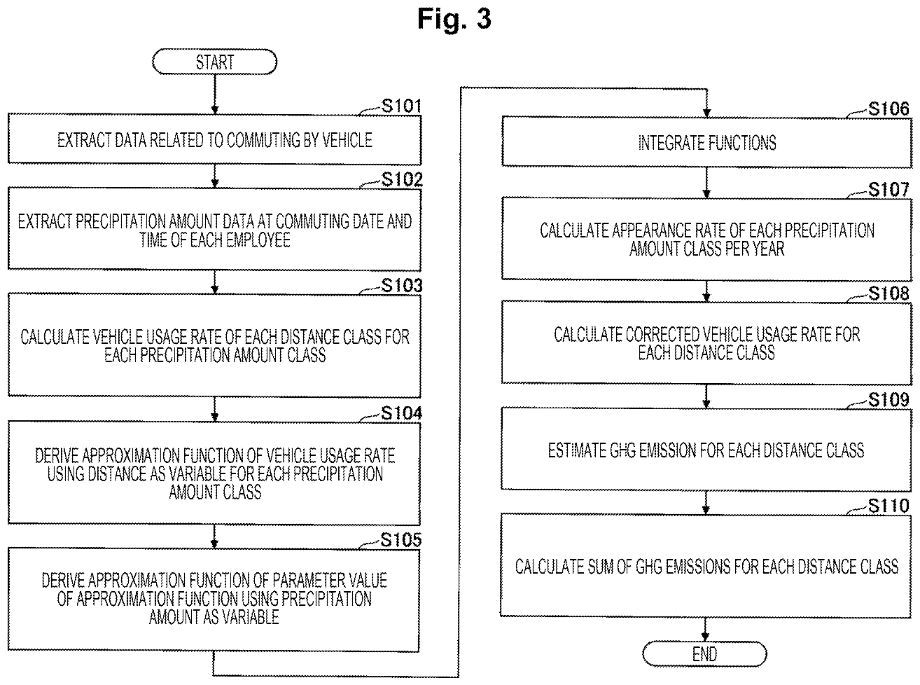

Hereinafter, a processing procedure executed by the GHG emission estimation device 10 will be described. FIG. 3 is a flowchart for describing an example of a processing procedure executed by the GHG emission estimation device 10.

In step S101, the data access unit 11 extracts the location of the home of each employee, the point-to-point distance, and the past record data from the commuting DB 121. The past record data extraction target period may be arbitrary, but is the past one year in the present embodiment.

Subsequently, the data access unit 11 extracts, for each employee, precipitation amount data at each commuting date and time and the departure point (the location of the home) extracted in step S101 for the employee from a precipitation amount DB (S102). The extracted precipitation amount data may be data of a meteorological observation station closest to the departure point, data of a meteorological observation station representing an area including all the target departure points, or data obtained by spatially interpolating meteorological observation station data, simulation, or the like. In the present embodiment, data of a meteorological observation station representing an area including all the target departure points is extracted. In addition, although various temporal resolutions of the precipitation amount data can be used, here, an hourly precipitation amount is extracted.

Subsequently, the statistic amount etc. calculation unit 12 sets a plurality of precipitation amount classes and a plurality of distance classes on the basis of the data (precipitation amount data at each commuting date and time for each employee in the past one year, and the point-to-point distance of each employee) extracted in step S102, and calculates, for each precipitation amount class, a vehicle usage rate, which is a ratio of the total number of employees (hereinafter, referred to as “the number of vehicle users”) who has actually commuted by vehicle to the total number of employees included in each distance class (S103). Note that the number of employees included in each distance class is common to each precipitation amount class. In addition, the precipitation amount class refers to each interval in a case where the precipitation amount is divided at regular intervals. Similarly, the distance class refers to each interval in a case where the distance is divided at regular intervals.

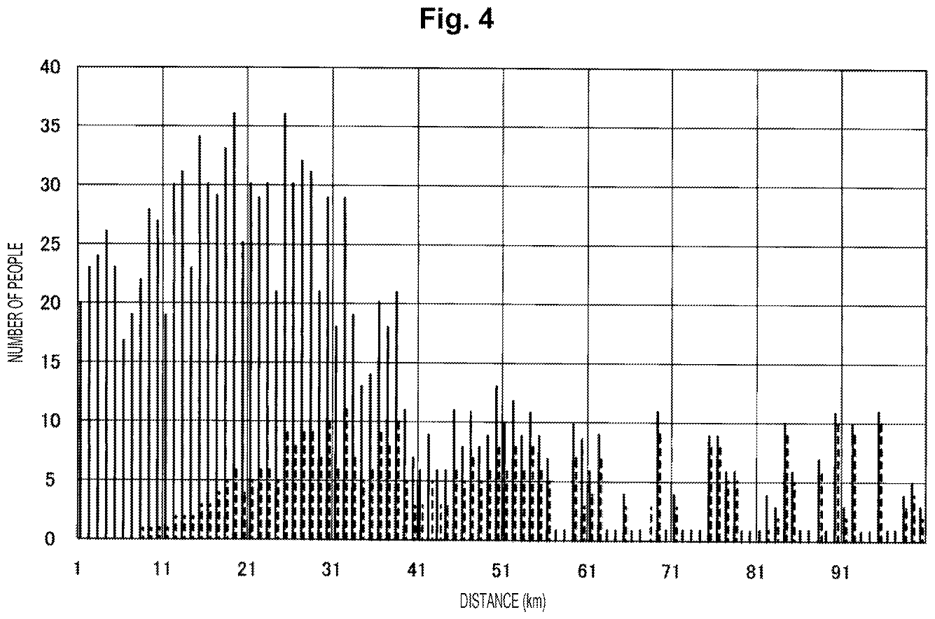

FIG. 4 is a diagram illustrating the number of employees included in each distance class and the number of vehicle users in a non-precipitation period (precipitation amount: 0 mm). Note that, here, the distance is a round-trip distance. In FIG. 4, the solid lines indicate the number of employees included in each distance class, and the broken lines indicate the number of vehicle users in a non-precipitation period.

Therefore, by dividing the number of vehicle users by the number of employees for each distance class, the vehicle usage rate of the distance class can be calculated.

Note that by executing similar processing for each of the other precipitation amount classes, the vehicle usage rate of each distance class is calculated for each precipitation amount class.

Subsequently, the function approximation unit 13 derives an approximation function of the vehicle usage rate using the distance as a variable for each precipitation amount class (S104). At this time, the function approximation unit 13 uses the same functional form for each precipitation amount class and approximates the locus of the vehicle usage rate for each precipitation amount class by parameter setting. Therefore, it is desirable that the functional form used here can express various distribution forms by parameter setting. In addition, when there is a plurality of parameters defining the function, it is desirable to perform approximation by changing only one parameter as much as possible and fixing the other parameters.

In the present embodiment, the Gompertz function is used. Definition Formula (1) of the Gompertz function is described below.

$$[ Math . 1 ]$$

$$f ( x ) = {Kb}^{e - cx} \qquad ( 1 )$$

where
x: distance
e: Napier's constant
K, b, c: parameter

There are three parameters of the Gompertz function, but in the present embodiment, only a parameter c is changed, parameters K and b are fixed, and approximation is performed by numerical calculation. Note that the parameter K is 1, which is the upper limit value of the vehicle usage rate.

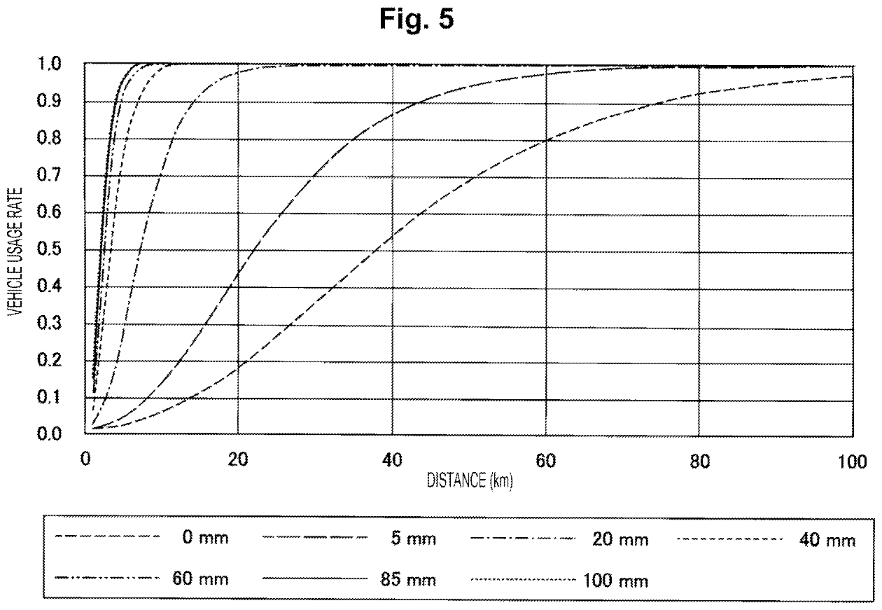

A graph based on the obtained approximation function is illustrated in FIG. 5. It can be confirmed that the vehicle usage rate tends to increase for all the distances as the precipitation amount increases.

Subsequently, the function approximation unit 13 derives a function that approximates the value of the parameter c of each precipitation amount class obtained in step S104 using the precipitation amount as a variable (S105). In the present embodiment, the Gompertz function is adopted again.

Definition Formula (2) of the Gompertz function used for approximation of the parameter c is described below.

$$[ Math . 2 ]$$

$$c ( y ) = {Lm}^{e - ny} \qquad ( 2 )$$

where
y: precipitation amount
e: Napier's constant
L, m, n: parameter

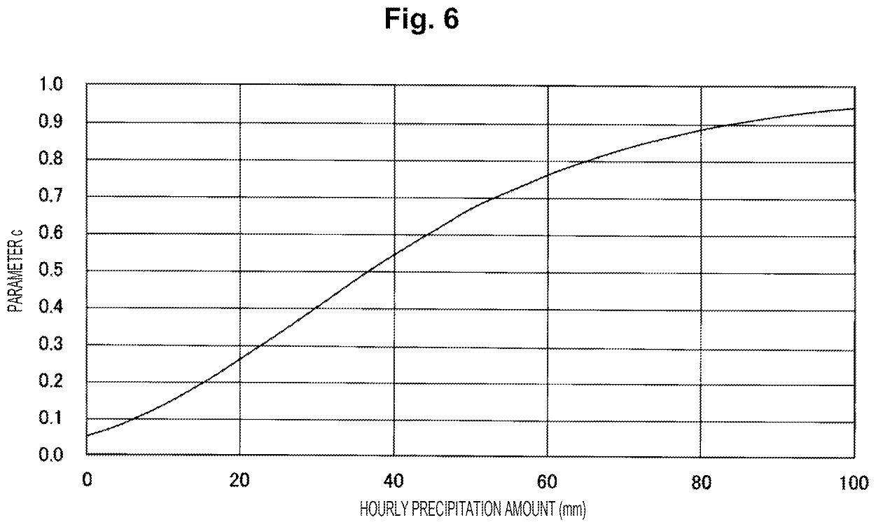

A graph based on the obtained approximation function is illustrated in FIG. 6.

Subsequently, the function approximation unit 13 integrates the approximation functions obtained in steps S104 and S105 (substitutes Definition Formula (2) into the parameter c of Definition Formula (1)) to derive a vehicle usage rate estimation function using the distance and the precipitation amount as variables (S106).

The vehicle usage rate estimation function (3) is described below. Note that the parameter K is 1, which is the upper limit value of the vehicle usage rate.

$$[ Math . 3 ]$$

$$g ( x , y ) = {Kb}^{{e}^{- {( {Lm}^{{e}^{- ny}} )}_{x}}} \qquad ( 3 )$$

where
x: distance
y: precipitation amount
e: Napier's constant
K, L, b, m, n: parameter

When the distance and the precipitation amount are known, the vehicle usage rate can be calculated for each combination of the distance and the precipitation amount by the function (3).

Here, a case of predicting a future GHG emission is considered. In general, it is easy to obtain and maintain distance data between the employee's home and work place, but in particular, it may be difficult to obtain a future estimated precipitation amount with high temporal resolution. With respect to this problem, in the present embodiment, an appearance rate of each precipitation amount class in the past is calculated from precipitation amount data of each place in the past several tens of years, and a weighted average value of the vehicle usage rate is obtained using the appearance rate.

In step S107, the statistic amount etc. calculation unit 12 calculates an appearance rate of each precipitation amount class in the past on the basis of the precipitation amount data. The precipitation amount data used at this time may be data of a meteorological observation station closest to the departure point, data of a meteorological observation station representing an area including all the target departure points, or data obtained by spatially interpolating meteorological observation station data, simulation, or the like. In the present embodiment, the appearance rate of a region is calculated using the precipitation amount data of a meteorological observation station representing the area.

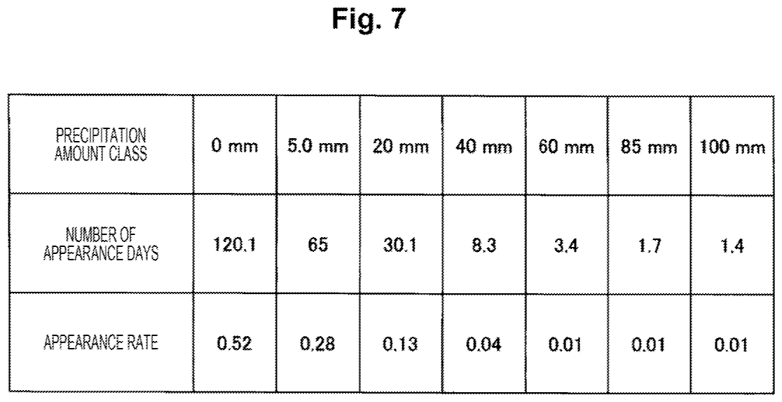

FIG. 7 illustrates an example of an appearance rate for each precipitation amount class at a certain meteorological observation station. In FIG. 7, the number of appearance days indicates the annual average number of days of each precipitation amount class based on the record in the past 30 years at a certain meteorological observation station. Thus, the annual average number of days is a real value. In addition, the denominator of the appearance rate is 230 days (the number of working days per year).

Subsequently, the function approximation unit 13 multiplies, for each distance class, an output value for each precipitation amount class of the vehicle usage rate estimation function (3) obtained in step S106 by the appearance rate of the corresponding precipitation amount class, obtains a sum thereof, and calculates a corrected vehicle usage rate, which is an annual weighted average value of the vehicle usage rate (S108). That is, the corrected vehicle usage rate is calculated for each distance class.

Specifically, the function approximation unit 13 sums up, for a distance class xⱼ, a value obtained by multiplying the output value of a distance x and a precipitation amount y in the vehicle usage rate estimation function (3) by an appearance rate Rᵢ of a precipitation amount class yᵢ to which the precipitation amount y belongs, and obtains the corrected vehicle usage rate in the distance class xⱼ to which the distance x belongs. A corrected vehicle usage rate estimation function (4) indicating such an operation will be described below.

$$[ Math . 4 ]$$

$${g}_{adj} ( {x}_{j} , {y}_{i} ) = {\sum }_{i} [ \{ {Kb}^{{e}^{- {( {Lm}^{{e}^{- ny}} )}_{x}}} \} * {R}_{i} ] \qquad ( 4 )$$

where
xⱼ: distance class j
Yᵢ: precipitation amount class i
Rᵢ: appearance rate of precipitation amount class i

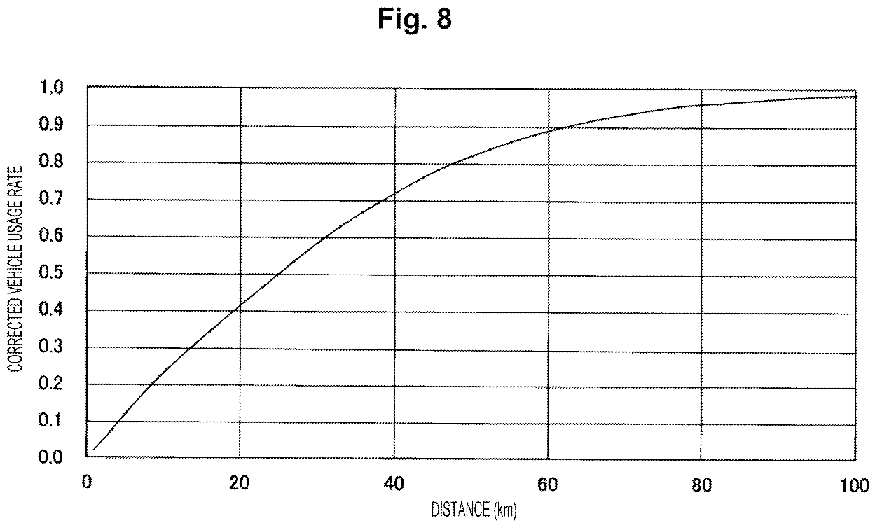

In addition, FIG. 8 illustrates an example in which the output value (corrected vehicle usage rate) for each distance class xⱼ of the corrected vehicle usage rate estimation function is plotted.

Subsequently, the GHG emission calculation unit 14 calculates an estimated value of the estimated GHG emission for each distance class xⱼ (S109).

Specifically, for each employee k, the GHG emission calculation unit 14 first multiplies a distance Dₖ (point-to-point distance) related to the employee k, the number of vehicles Nₖ, the number of commuting days Tₖ of the employee k in one year, a corrected vehicle usage rate g_{adj}(xⱼ, yᵢ) in the distance class xⱼ to which the distance Dₖ belongs, and a GHG intensity BU according to Formula (5) below to calculate an estimated value Qⱼₖ of the estimated GHG emission.

$$[ Math . 5 ]$$

$${Q}_{jk} = {D}_{k} * {N}_{k} * {T}_{k} * {g}_{adj} ( {x}_{j} , {y}_{i} ) BU \qquad ( 5 )$$

where
Qⱼₖ: estimated GHG emission of distance class xⱼ to which distance Dₖ belongs
Dₖ: commuting distance of employee k
Nₖ: number of vehicles of employee k
Tₖ: number of commuting days of employee k
Xⱼ: distance class to which distance Dₖ belongs
BU: GHG intensity

However, since one employee usually uses one vehicle in one commuting, Nₖ=1 in the present embodiment assuming that each employee commutes by private vehicle. However, for example, in a case where two or more employees share a ride and commute or in a case where two or more employees commute by commuter bus, the value of Nₖ is a reciprocal of the number of people on the same vehicle. Alternatively, Formula (5) may be calculated for each vehicle used for commuting. In this case, k indicates a vehicle, and Tₖ is always 1. In addition, in the present embodiment, since it is assumed that the commuting route of the employee is the same every time, the distance Dₖ is uniquely determined for each employee.

The GHG emission calculation unit 14 calculates the sum of Qⱼₖ calculated for each employee for each distance class xⱼ (for each Qⱼₖ having common j), thereby calculating an estimated value Qⱼ of the estimated GHG emission for each distance class xⱼ.

Subsequently, on the basis of Calculation Formula (6) below, the GHG emission calculation unit 14 calculates the sum of an estimated value Qⱼ of estimated GHG emissions for each distance class xⱼ as an estimated value of estimated GHG emissions due to vehicle commuting of employees of the company, and outputs a calculation result (S110).

$$[ Math . 6 ]$$

$$Q = {\sum }_{j} {Q}_{j} \qquad ( 6 )$$

where
Q: estimated GHG emission

As described above, an example has been indicated in which two environmental factors that define the use/non-use of the vehicle are set: a distance to a destination and a precipitation amount, and the GHG emission due to commuting by the employee of a certain company using a private vehicle is estimated.

As described above, according to the present embodiment, GHG emissions reflecting a use environment of vehicles can be estimated.

Note that, in the present embodiment, the distance and the precipitation amount are adopted as environmental factors, but other environmental factors, for example, those indicating ease of access to public transportation can also be used. In addition, in addition to the estimation of GHG emissions, a calculation system that reflects environmental factors and human thought/judgment based on the environmental factors as factors can cope with the functions and processing described in the present embodiment.

Note that, in the present embodiment, the function approximation unit 13 is an example of a first derivation unit, a second derivation unit, a third derivation unit, and a first calculation unit. The GHG emission calculation unit 14 is an example of a second calculation unit.

Although the embodiment of the present invention has been described in detail above, the present invention is not limited to such a specific embodiment, and various modifications and changes can be made within the scope of the gist of the present invention described in the claims.

### REFERENCE SIGNS LIST

10 GHG emission estimation device
11 Data access unit
12 Statistic amount etc. calculation unit
13 Function approximation unit
14 GHG emission calculation unit
100 Drive device
101 Recording medium
102 Auxiliary storage device
103 Memory device
104 Processor
105 Interface device
121 Commuting DB
122 Environment DB
123 Intensity DB
B Bus

1. A GHG emission estimation method executed by a computer including a memory and a processor, the GHG emission estimation method comprising:
deriving, based on a vehicle usage rate of each distance class among distance classes for each precipitation amount class among precipitation amount classes based on a vehicle commuting distance of each employee among employees and precipitation amount data of each commuting day in a past, for said each precipitation amount class, a first approximation function that estimates the vehicle usage rate using a distance as a variable;
deriving a second approximation function that approximates a parameter value of the first approximation function using a precipitation amount as a variable;
integrating the first approximation function and the second approximation function to derive a function for estimating the vehicle usage rate using the distance and the precipitation amount as variables;
calculating a corrected vehicle usage rate in which an appearance rate of said each precipitation amount class is reflected in an output value of the function for said each precipitation amount class among the distance classes; and
calculating an estimated value of estimated GHG emissions based on the distance and a number of commuting days said each employee having the distance belonging to said each distance class, the corrected vehicle usage rate, and a GHG intensity among the distance classes.

2. The GHG emission estimation method according to claim 1, wherein upon deriving the first approximation function, calculating the corrected vehicle usage rate that is a weighted average value of an output value of the function for said each precipitation amount class by the appearance rate of the precipitation amount class among the distance classes.

3. A GHG emission estimation device comprising:
a memory; and
a processor configured to:
derive, based on a vehicle usage rate of each distance class among distance classes for each precipitation amount class among precipitation amount classes based on a vehicle commuting distance of each employee among employees and precipitation amount data of each commuting day in a past, for said each precipitation amount class, a first approximation function that estimates the vehicle usage rate using a distance as a variable;
derive a second approximation function that approximates a parameter value of the first approximation function using a precipitation amount as a variable;
integrate the first approximation function and the second approximation function to derive a function for estimating the vehicle usage rate using the distance and the precipitation amount as variables;
calculate a corrected vehicle usage rate in which an appearance rate of said each precipitation amount class is reflected in an output value of the function for said each precipitation amount class among the distance classes; and
calculate an estimated value of estimated GHG emissions based on the distance and a number of commuting days of said each employee having the distance belonging to said each distance class, the corrected vehicle usage rate, and a GHG intensity among the distance classes.

4. The GHG emission estimation device according to claim 3, wherein the processor calculates the corrected vehicle usage rate that is a weighted average value of an output value of the function for said each precipitation amount class by the appearance rate of the precipitation amount class among the distance classes.

5. (canceled)

6. A non-transitory computer-readable recording medium having computer-readable instructions stored thereon, which, when executed, cause a computer to execute a method, the method comprising:
a first derivation procedure of deriving, for each precipitation amount class, a first approximation function that estimates a vehicle usage rate using a distance as a variable on a basis of a vehicle usage rate of each distance class for each precipitation amount class based on a vehicle commuting distance of each employee and precipitation amount data of each past commuting day;
a second derivation procedure of deriving a second approximation function that approximates a parameter value of the first approximation function using a precipitation amount as a variable;
a third derivation procedure of integrating the first approximation function and the second approximation function to derive a function for estimating a vehicle usage rate using the distance and the precipitation amount as variables;
a first calculation procedure of calculating a corrected vehicle usage rate in which an appearance rate of the precipitation amount class is reflected in an output value of the function for each precipitation amount class for each distance class; and
a second calculation procedure of calculating an estimated value of estimated GHG emissions on a basis of the distance and a number of commuting days of each employee having the distance belonging to the distance class, the corrected vehicle usage rate, and a GHG intensity for each distance class.
